(19) United States
(12) Patent Application Publication
(10) Pub. No.: US 2005/0207281 A1
(43) Pub. Date: Sep. 22, 2005

(54) Watch

(75) Inventor: Burkhard Geyer, Glashutte (DE)

Correspondence Address: COHEN, PONTANI, LIEBERMAN & PAVANE, 551 FIFTH AVENUE, SUITE 1210, NEW YORK, NY, 10176, US

(73) Assignee: Lange Uhren GmbH

(21) Appl. No.: 11/080,193

(22) Filed: Mar. 15, 2005

(30) Foreign Application Priority Data
Mar. 16, 2004 (DE) 10 2004 012 628.3

(51) Int. Cl. G04B 49/00

(52) U.S. Cl. 368/15; 368/223

(57) ABSTRACT

A watch includes an hour hand which can be driven by a watch movement rotatably about a hand axis by one turn every twelve hours, and a display element for displaying the day and night information. The display element is drivable about a further axis by the watch movement about the hand axis in the same rotational direction as the hour hand by half a turn every twelve hours and has an annular or circular marking of the day and/or night hours, which marking is concentric to the hand axis.

### BACKGROUND OF THE INVENTION

1. Field of the Invention

The invention relates to a watch, especially a wristwatch, having an hour hand which can be driven by a watch movement rotatably about a hand axis by one turn every 12 hours, and having a display element, for displaying the day and night information, which can be driven rotatably about a further axis by the watch movement.

2. Description of the Related Art

In watches which have an hour hand and a diplay element for indicating day and night information, the display of the zone time of a second time zone may include a further display element formed by a sector disc, one half of which forms a dark-coloured and the other half of which forms a light-coloured sector. The further display element is disposed beneath a window of a dial plate, and rotates about a further axis parallel to the hand axis. Every six hours, the sector disc is rotated onward by a quarter of a turn in the clockwise direction. The night hours between 18:00 hours and 6:00 hours are represented by the dark underlay of the window and the day hours between 6:00 hours and 18:00 hours by the light underlay of the window.

### SUMMARY OF THE INVENTION

The object of the present invention is to provide a watch having an hour hand driven by a watch movement and a display element for displaying night and day information, which allows an easily readable clear information of the day time and night time display.

This object is achieved by an arrangement in which the further display element is driven rotatably about the hand axis in the same rotational direction as the hour hand by half a turn every 12 hours and has an annular or circular marking of the day and night hours, which marking is concentric to the hand axis.

According to the inventive configuration, the hour hand covers the region of the night hour marking between 18:00 hours and 6:00 hours and the hour hand covers the region of the day hour marking between 6:00 hours and 18:00 hours. An observer can therefore immediately detect both the time on a 12-hour scale, on the basis of the customary angular position of the hour hand, and the night or day classification, on the basis of the marking. No complex gearing arrangements are necessary in this connection.

The marking indicating night and day regions may be formed from two semi-circles of different visual design, combined to form a circle, so that the respective visual design of the marking over which the hour hand is situated yields the night or day classification.

Another, likewise simple configuration consists in the fact that the marking of the day and night hours is a 24-hour scale.

The day or night classification can thus be detected from the 24-hour scale.

The 24-hour scale is preferably, in this case, of annular configuration.

The 24-hour scale may have the digits 1 to 24 distributed evenly one after the other in the clockwise direction.

Another embodiment in which the night or day classification may be quickly recognized includes a 24-hour scale formed from two half-rings of different visual design, combining to form a ring.

The semi-circles or the half-rings may be different in colour, i.e., light-coloured and dark-coloured, to emphasize the different regions.

If the hour hand and the display element of the zone time are assigned to a second time zone display and are manually adjustable in 12 hourly increments about the hand axis, and if the watch possesses a further hour hand, which is assignable to the zone time of a first time zone display and can be driven rotatably about an axis, then the local time can be indicated by the further hour hand of the first time zone display and the time in another time zone by the hour hand, for example, complete with night time or day time information of the second time zone display.

A compact representation is achieved when the further hour hand is driven rotatably about the hand axis by one turn every 12 hours, so that the two hour hands and the marking rotate about a common axis. In order to differentiate between the hour hand and the further hour hand, these can be differently designed or differently coloured.

The two hour hands can also, of course, be rotatable about two mutually parallel hand axes.

For setting to a specific time zone, the hour hand can be manually adjustable, jointly with the display element, in 12 hourly increments about the hand axis.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a front view of a first embodiment of a watch having a first time display,

FIG. 1a is a schematic partial cross-sectional diagram showing the watch movement,

FIG. 2 is a front view of the watch according to FIG. 1 having a second time display,

FIG. 3 is a front view of a second embodiment of a watch,

FIG. 4 is a front view of a third embodiment of a watch having the first time display,

FIG. 5 is a front view of the embodiment of FIG. 4, having another time display,

FIG. 6 is a front view of the embodiment of FIG. 4, having a further time display,

FIG. 7 is a front view of the embodiment of FIG. 4, having a further time display,

FIG. 8 is a front view of the embodiment of FIG. 4, having a further time display, and

FIG. 9 is a front view of the embodiment of FIG. 4, having yet another time display.

### DETAILED DESCRIPTION OF THE PRESENTLY PREFERRED EMBODIMENTS

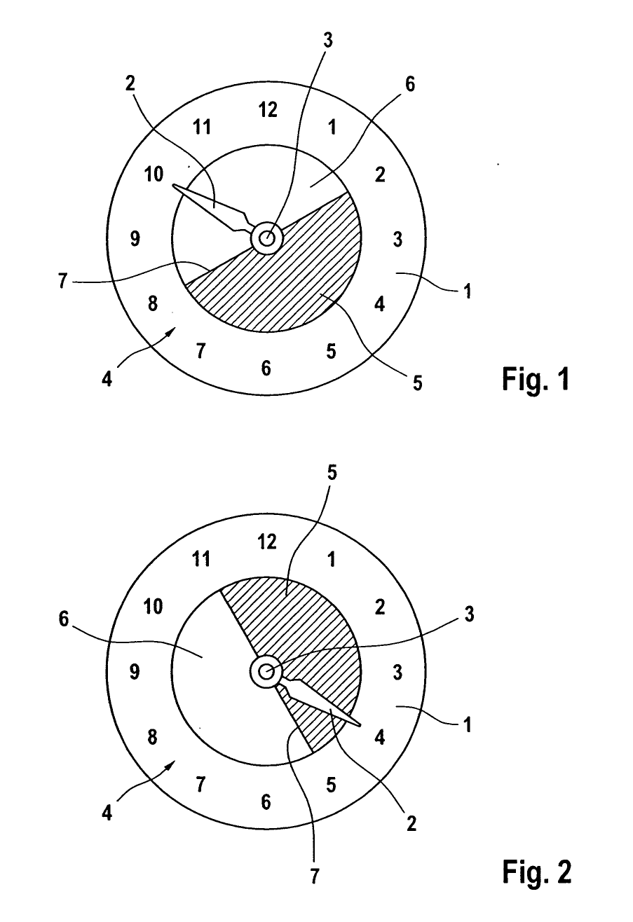

As shown in FIG. 1, the watch according to the present invention includes an hour hand 2, which can be driven by a watch movement 20 (see FIG. 1a) rotatably about a hand axis 3 by one rotation every twelve hours.

A hand tip of the hour hand 2 sweeps along an annular scale 1 arranged concentric to the hand axis 3 and on which hour indications from one to twelve are evenly spaced.

Also concentric to the hand axis 3, roughly in the same plane as the scale 1, a marking formed from differently coloured semi-circles 5 and 6 combining to form a disc-like circle 4 is disposed radially within the scale 1. The semi-circle 5 may from example, exhibit a darker color than the semi-circle 6 to differentiate the night/day classification.

The circle 4 is driven by the watch movement 20 rotatably about the hand axis 3 in the same rotational direction as the hour hand 2 by half a turn every twelve hours. FIG. 1a is a schematic depiction of the watch movement 20 connected to the hour hand 2 and the circle 4. Any known or hereafter developed type of watch movement may be used, as long as the relative movements between the hour hand 2 and the marking as described herein are effected.

A dividing line 7 extends through the hand axis between the two semi-circles 5, 6. The hour hand 2 and the dividing line 7 are positioned relative to each other in such a way that the dividing line 7, when the hand tip is pointing at the “12” on the scale 1, extends from the “9” to the “3” on the scale.

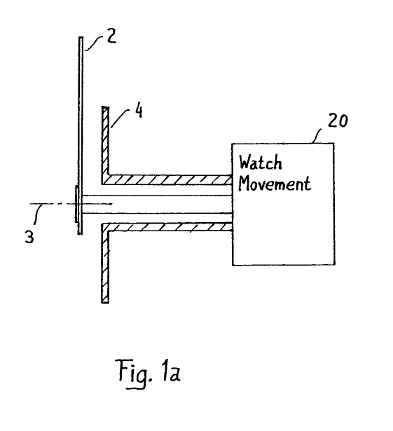

FIG. 1 shows the position of the hour hand 2 and the circle 4 at 10 a.m. and FIG. 2 shows the positions at 4 a.m.

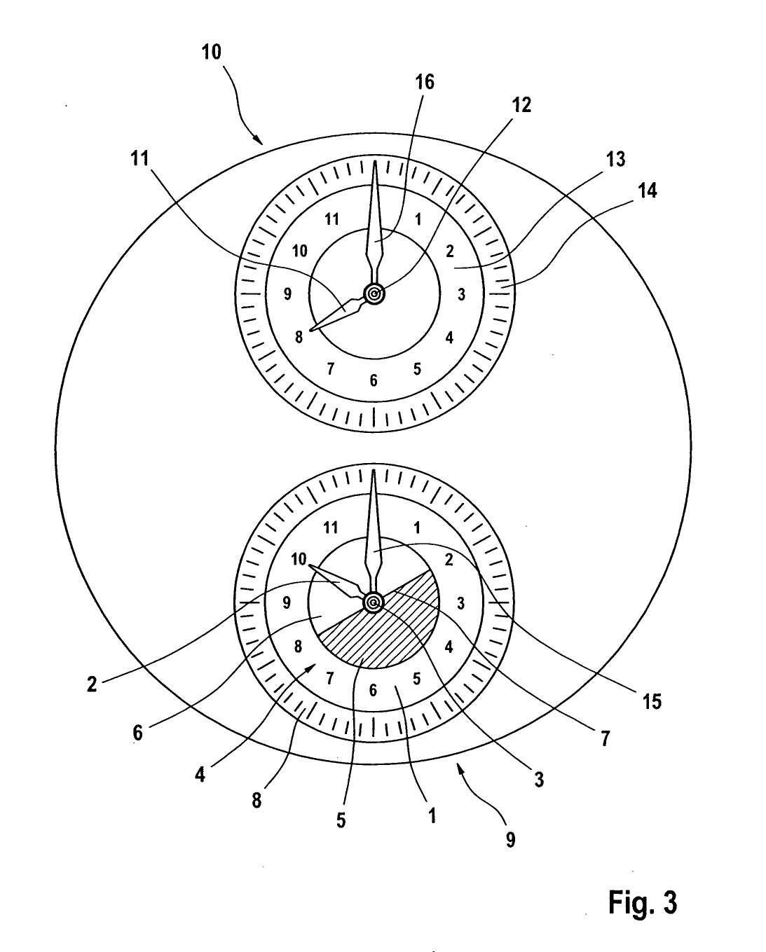

FIG. 3 shows an embodiment in which the scale 1 is additionally enclosed by a minutes scale 8.

The display in FIG. 3 with the hour hand 2, the circle 4, the scale 1, and the minutes scale 8 form a second time zone display 9 for the representation of a second zone time.

A first time zone display 10 is arranged above this second time zone display 9. The first time zone display 10 possesses a further hour hand 11, which can be driven by the watch movement rotatably about an axis 12 parallel to the hand axis 3 by one turn every twelve hours and which indicates a first zone time.

A further annular hours scale 13 is arranged concentric to the axis 12 and has the digits 1 to 12 evenly distributed. The hours scale 13 is enclosed, in turn, by a second minutes scale 14.

The second time zone display 9 additionally includes a minute hand 15 arranged such that it can be driven by the watch movement rotatably about the hand axis 3, and the first time zone display 10 includes a minute hand 16 likewise about the axis 12.

The hour hand 2 and the circle 4 are manually adjustable in 12 hourly increments about the hand axis, so that the respectively desired zone time of the second time zone can be set.

In FIG. 3, the second time zone display 9 indicates the zone time 10 a.m. and the first time zone display 10 indicates the zone time eight o'clock.

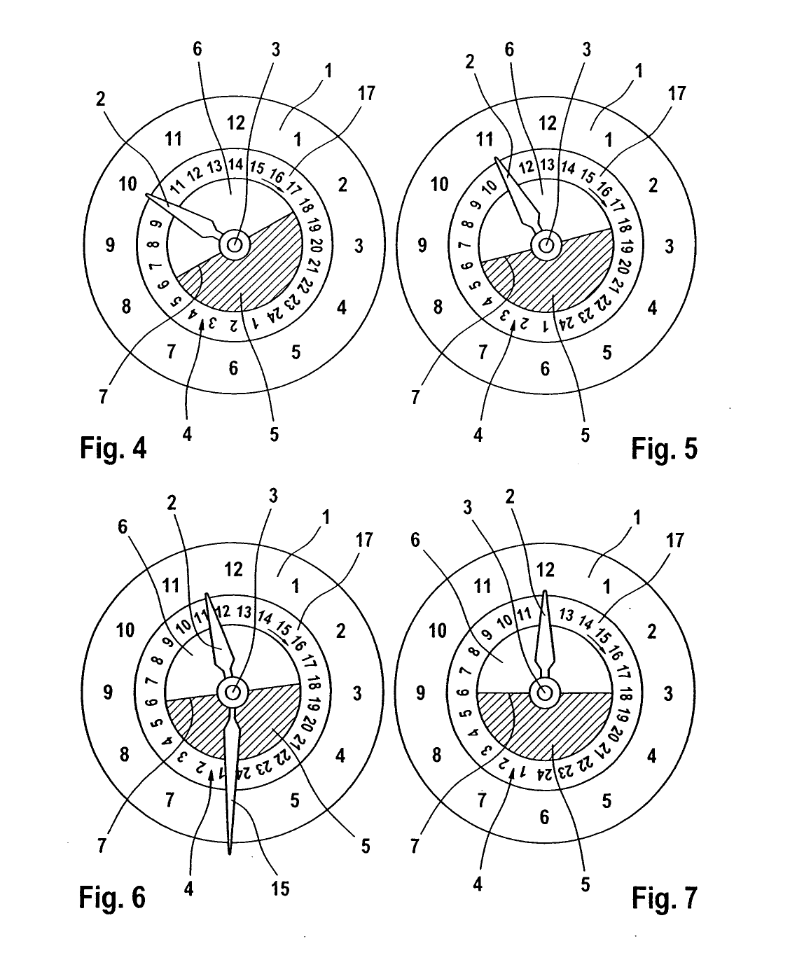

In FIGS. 4 to 9, the circle 4 of the marking is enclosed by an annular 24-hour scale 17, which can be driven by the watch movement jointly with the circle 4 and bears the digits 1 to 24 evenly distributed. In this case, the dividing line 7 between the two semi-circles 5 and 6 extends from the “6” to the “18” on the 24-hour scale 17.

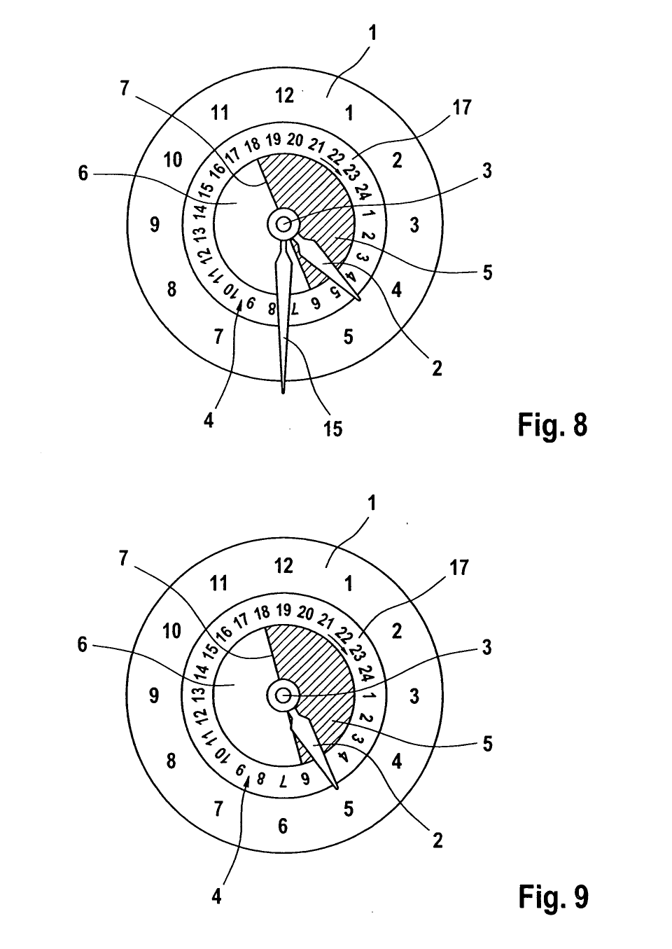

As represented in FIGS. 6 and 8, a minute hand 15 may also be arranged such that the minute hand 15 is also driven by the watch movement rotatably about the hand axis 3.

In FIG. 4 to 9, the following times are indicated: FIG. 4 illustrates the hour hand 2 and circle 4 at 10:00 a.m.; FIG. 5 illustrates that hour hand 2 and circle 4 at 11:00 a.m.; FIG. 6 illustrates the hour hand 2, the minute hand 15, and circle 4 at 11:30 a.m.; FIG. 7 illustrates the hour hand 2 and the circle 4 at 12:00 noon; FIG. 8 illustrates that hour hand 2, the minute hand 15, and the circle 4 at 4:30 a.m.; and FIG. 9 illustrates the hour hand 2 and the circle 4 at 5:00 a.m.

Since the hour hand 2, in the various illustrative embodiments, rotates once every twelve hours and the circle 4 forming the marking makes only half a turn in twelve hours, in addition to the quantitative time given by the hour hand 2, the qualitative day or night time is always indicated by the position of the hour hand 2 relative to the marking. The time is easily and quickly read, since the hour hand 2 indicates in the standard 12 hour display.

The catch-locking of the hour hand 2 in twelve increments, i.e. every 30°, leads to lower tolerance requirements, despite the smallness of the watch parts.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A watch, comprising:
a hour hand rotatably mounted for rotation about a hand axis and drivable by a watch movement about said hand axis by one turn every 12 hours; and
a display element rotatably mounted for rotation about said hand axis and displaying night and day information, said display element being drivable by the watch movement in the same direction as said hour hand by a half turn every 12 hours, said display element comprising one of an annular and circular marking of the night and day information, said marking being concentric to said hand axis.

2. The watch of claim 1, wherein said marking includes a circle including two semi-circles, each of said semi-circles having different visual designs.

3. The watch of claim 1, wherein said marking includes a 24-hour scale.

4. The watch of claim 3, wherein said 24-hour scale comprises an annular configuration.

5. The watch of claim 4, wherein said 24-hour scale includes the digits 1 to 24, evenly spaced one after the other in the clockwise direction.

6. The watch of claim 4, wherein said 24-hour scale includes two half-rings of different visual design connected to form a ring.

6. The watch of claim 4, wherein said 24-hour scale includes two half-rings of different visual design connected to form a ring.

7. The watch of claim 6, wherein one of said half-rings is a different color than the other of said half-rings.

8. The watch of claim 1, wherein said hour hand and said display element are assigned to a second time zone display and are manually adjustable in 12 hourly increments about the hand axis, said watch further comprising a first time zone display including a further hour hand rotatable about a second axis.

9. The watch of claim 8, wherein said further hour hand is drivable about said second axis by one turn every 12 hours.

10. The watch of claim 8, wherein said hour hand is manually adjustable, jointly with the display element, in 12 hourly increments about said hand axis.

11. The watch of claim 2, wherein said marking includes a 24-hour scale.

12. The watch of claim 7, wherein one of said half-rings is a lighter color than the other of said half-rings.

13. The watch of claim 2, wherein one of said semi-circles is a different color than the other of said semi-circles.

14. The watch of claim 11, wherein one of said semi-circles is a lighter color than the other of said semi-circles.
